(19) United States
(12) Patent Application Publication
(10) Pub. No.: US 2011/0226974 A1
(43) Pub. Date: Sep. 22, 2011

(54) METHOD FOR PRODUCING AN ELECTROMAGNETIC ACTUATING DEVICE, PARTICULARLY FOR ACTUATING VALVES, AND ACTUATING DEVICE PRODUCED ACCORDING TO THE METHOD

(76) Inventors: Martin Bill, Saarbrücken (DE); Christoph Meyer, Saarbrucken (DE)

(21) Appl. No.: 12/998,649

(22) PCT Filed: Nov. 13, 2009
(86) PCT No.: PCT/EP2009/008101

§ 371 Date: May 13, 2011

(30) Foreign Application Priority Data
Dec. 10, 2008 (DE) 10 2008 061 414.9

(51) Int. Cl. F16K 31/02; B23P 11/02

(52) U.S. Cl. 251/129.01; 29/592.1

(57) ABSTRACT

The invention relates to a method for producing an electromagnetic actuating device, particularly for actuating valves, an armature (3) being formed within a pole tube (1) guiding an armature space (11) by configuring a mechanical connection between a pole body (13) and at least one further part (9, 15) of the pole tube (1), such as the pole core (9), characterized in that the mechanical connection is formed by thermal shrinking, such that the tube body (13) is heated and pressed onto the further part (9, 15).

The invention relates to a method for producing an electromagnetic actuating device, particularly for actuating valves, in which a pole tube which guides an armature within an armature space is formed by configuring a mechanical connection between a tube body and at least one further part of the pole tube, for example, a pole core. Furthermore, the invention relates to an actuating device produced according to the method.

Electromagnetic actuating devices of this type, which are also referred to as proportional solenoids or switching solenoids in the technical jargon, are readily available on the market in a plurality of embodiments. A device of this type which is made as a switching solenoid is described, for example, in DE 103 27 209 B3. In devices of this type, the armature, with electrical excitation of the pertinent coil winding, executes a displacement motion in the pole tube. If the energization of the coil winding is dispensed with, generally the armature is reset into an initial position via a reset spring. In most cases, the reset force acts on the armature via the actuating part connected to the armature, which is made essentially bolt-like, which extends through the pole core, and which triggers a pertinent actuating process, for example, in a valve connected from the outside for routing fluid flows. The reset spring can be located in the actuating device itself and/or preferably on the valve which can optionally be actuated.

In such actuating devices, the operational reliability depends largely on the pole tube being mechanically configured such that it meets operation-dictated requirements, especially also in long-term operation. Accordingly, in production, special attention is given to the formation of mechanical connections between pole tube components, which are critical to operation. Hence, in the prior art, joining methods such as weld connections or connections by crimping or beading are used. If the required reliability of the mechanical connections is to be ensured, such methods must be carried out meticulously and in a time-consuming manner; this causes comparatively high production costs.

In light of the foregoing, the object of the invention to provide a method with which these actuating devices can be produced in a simple and comparatively economical manner and are characterized nonetheless by especially high operational reliability.

According to the invention, this object is achieved by a method which has the features of claim 1 in its entirety.

Accordingly, an essential particularity of the invention consists in that in the production of the pole tube, mechanical connections between a tube body and at least one further part which belongs to the pole tube are formed by thermal shrinkage, the tube body being heated and pressed onto the pertinent further part. The implementation of connections by thermally shrinking on enables not only efficient, i.e., quick and cost-efficient, production, but also leads to especially good mechanical properties of the pole tube formed from several parts so that, in spite of low production costs, high operational reliability of the actuating device is ensured.

The method according to the invention also enables especially efficient production of multipart pole tubes such that the tube body is connected by thermal shrinkage both to the pole core formed by a first rotating part and also to a second rotating part which forms the displacement guide of the armature by the heated tube body being pressed onto the outer jacket surfaces of the two rotating parts.

For operation of the actuating device at a high pressure level, in the production of the connections, the process can take place such that an adhesive, preferably an adhesive which forms a sealant and/or filler, is applied to the connection sites before pressing the heated tube body on. This ensures that even at high pressure levels, tightness and pressure integrity of the connections are ensured.

With respect to the implementation of a magnetic decoupling, it can be favorable to form the tube body from a nonmagnetic metal.

Preferably, in this case, the process is carried out such that the pole core and a second rotating part are connected to one another via the tube body with formation of an intermediate space which forms an air gap and which effects a magnetic decoupling.

In preferred exemplary embodiments, the second rotating part which forms the actual displacement guide for the armature is provided with a closed end which forms the stroke limitation of the armature.

In this case, it is possible to proceed such that a separate end part is attached to the second rotating part as the stroke limitation or that the second rotating part is made with an end part which is integral with it. The second rotating part, in this case, has the shape of a hollow cylinder that is open on one end and is closed on the other end by a bottom. In exemplary embodiments in which the end part which forms the stroke limitation is a separate component, the second rotating part can be made as hollow cylinder whose one end is provided with the separate end part which forms the stroke limitation by means of a flange connection.

The subject matter of the invention is also an actuating device which is produced according to the method specified in one of the claims 1 to 11 and which has the features of claim 12 in its entirety.

The invention is detailed below using exemplary embodiments shown in the drawings.

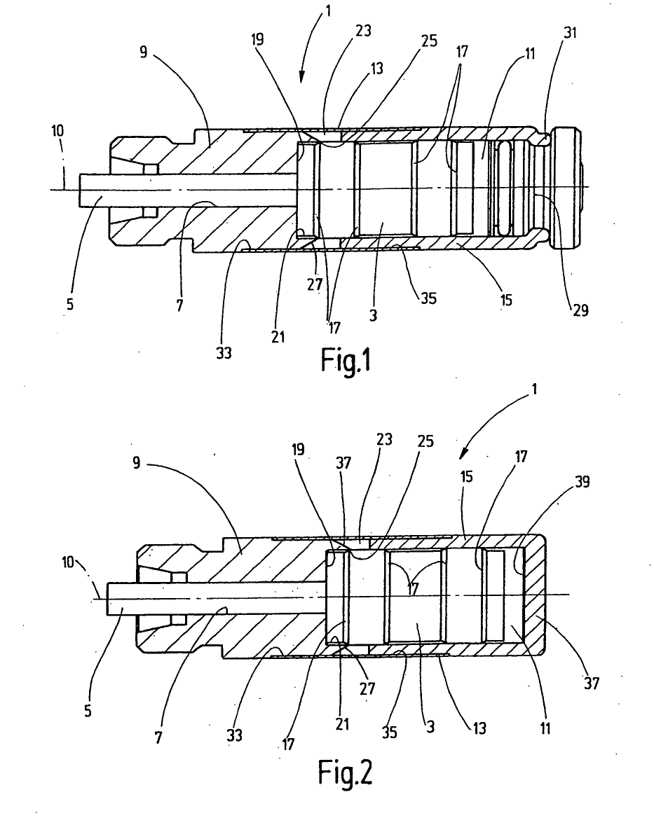

FIG. 1 shows a longitudinal section of only the pole tube drawn schematically slightly simplified, with an armature of one exemplary embodiment of the actuating device according to the invention, which armature is arranged in the pole tube;

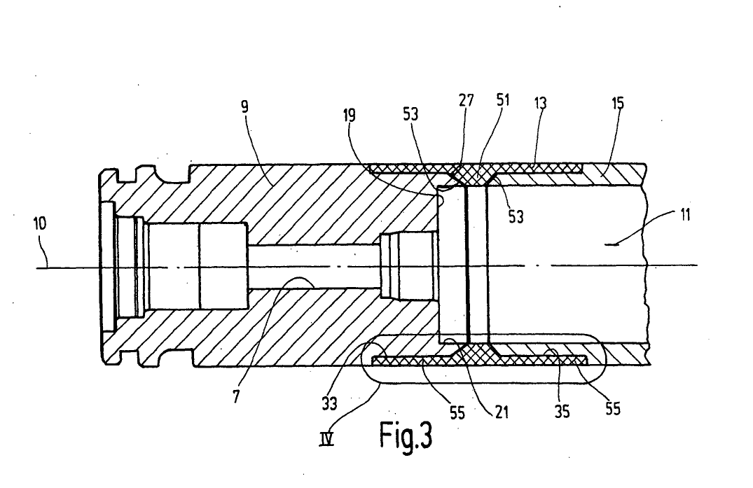

FIG. 2 shows a longitudinal section of a second exemplary embodiment which corresponds to FIG. 1;

FIG. 3 shows, in a schematically slightly simplified drawing, a longitudinal section of the longitudinal segment of only the pole tube, wherein said segment borders the pole core, which section is drawn schematically slightly simplified, without an armature according to a further exemplary embodiment of the actuating device according to the invention;

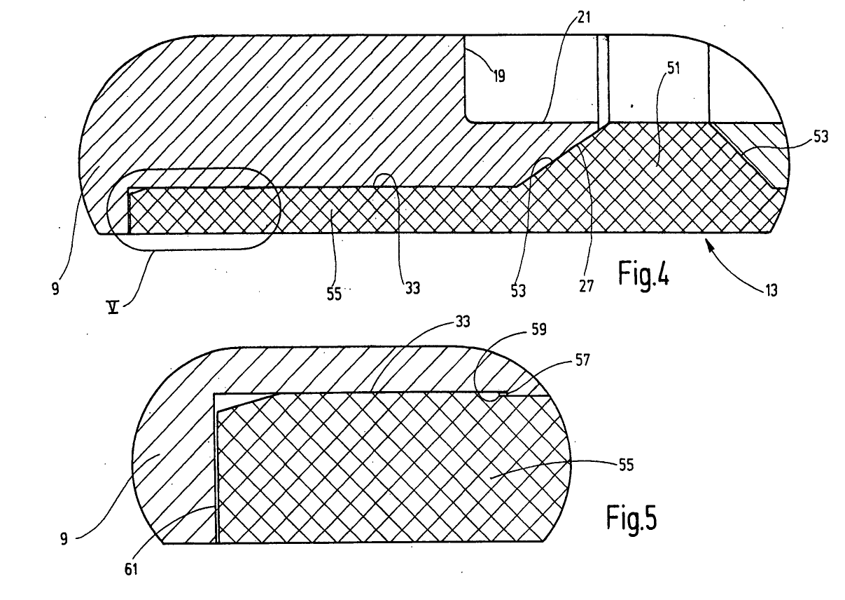

FIG. 4 shows a partial extract of the region designated as IV in FIG. 3, which extract is shown highly enlarged compared to FIG. 3, and

FIG. 5 shows a partial extract of the region designated as V in FIG. 4, which extract is shown highly enlarged compared to FIG. 4.

In the drawings of the respective electromagnetic actuating device, only the pole tube is shown; it is designated as a whole as 1, and an armature 3 is movably guided therein and to which a rod-like actuating part 5 is attached which extends through a central bore. 7 of a pole core 9 to the outside. A coil housing, which at least partially surrounds the pole tube 1 with coil winding located therein as well as electrical connecting elements, is not shown in the drawings since it can be made in the conventional, suitable manner which is familiar to one skilled in the art. Nor does the simplified drawing show any special configuration features of the rod-like actuating part 5, as they can be provided according to the prior art, cf. DE 10 2004 028 871 A1, in order to form a fluid connection into the armature space 11 located in the pole tube 1, along the actuating part 5.

In the exemplary embodiments shown in the drawings, the pole tube 1 is formed from three main parts, specifically, the pole core 9 produced as a rotating part, a tube body 13 of nonmagnetic metal, and a second rotating part 15 which defines a hollow cylinder. Said second rotating part in the interior forms the armature space 11 and the displacement guide for the armature 3, which is provided on its outer periphery with lubrication grooves 17 interrupting its cylinder jacket surface. In the position of the armature 3, which is shown in FIGS. 1 and 2, in its end position on the left side in the drawings, it is in contact with the bottom surface 19 of a circular cylindrical depression 21 which is located on the inner end of the pole core 9. The pole core 9 as the first rotating part and the second rotating part 15, which forms the actual displacement guide of the armature 3, are mechanically connected securely to one another via the nonmagnetic tube body 13 such that an intermediate space forming an air gap 23 is formed between the end of the pole core 9 and the rotating part 15. On the air gap 23, the pole core 9 forms a control edge 25. The latter is formed by the pointed end edge of the depression 21 in the pole core 9 by the end edge 21 being adjoined by an inclined plane 27. The air gap 23 on the pole core 9 effects a magnetic decoupling of the parts of the pole tube 1 which are connected via the tube body 13.

The position of the armature 3 shown in FIGS. 1 and 2 corresponds to the operating state of the energized coil winding. When there is no energization, the armature 3 moves to the right in the drawings under the influence of the reset spring into an end position which is defined by a stroke limiter. To form the stroke limiter, in the example of FIG. 1, there is an end body 29 which is connected to the rotating part 15 and which is anchored on the end of the rotating part 15 by means of a flange 31.

The tube body 13 on the pole core 9 and on the rotating part 15 overlaps the connecting surfaces 33 and 35, which are each formed by circular cylindrical depressions in the outer jacket surface of the pole core 9 and rotating part 15. Here the depth of the depressions which form the connecting surfaces 33 and 35 is adapted to the wall thickness of the tube body 13 such that the tube body 13, when it is in position on the connecting surfaces 33, 35, on its outside continues the circular cylindrical outer contour of the pole tube 1 without an offset. As is apparent from the drawings, the wall thickness of the tube body 13 is substantially smaller than that of the hollow cylindrical rotating part 15, the thickness ratio being preferably in the range from 1:6 to 1:3. In the example shown in FIGS. 1 and 2, the size ratio is approximately 1:4. As a result of the comparatively small wall thickness of the tube body 13 and the resulting small depth of the depression which forms the connecting surface 35, the material cross section of the rotating part 15 is reduced only slightly in the region of the connecting surface 35.

In the production of the pole tube 1, the mechanical connection of the tube body 13 on the connecting surface 33 of the pole core 9 and on the connecting surface 35 of the rotating part 15 is executed such that the tube body 13 is thermally shrunk onto the pole core 9 and the rotating part 15. The process is such that the tube body 13 is heated to a temperature in the region of approximately 180° C. and is pressed onto the connecting surfaces 33 and 35 on the pole core 9 and on the rotating part 15, the pole core 9 and the rotating part 15 preferably being at a temperature which corresponds to the ambient level. Depending on the thermal expansion properties of the participating metallic materials used, there can also be cooling of the pole core 9 and/or the rotating part 15 to a lower temperature in order to optimize the shrinking-on process. With respect to operational reliability in long-term operation and under varying temperature conditions which occur in use, it is advantageous if the thermal expansion of the tube body 13 is similar to the thermal expansion of the pole core 9 and rotating part 15.

On the pole core 9 and the rotating part 15, the connection formed by thermal shrinking is sufficiently tight and pressure-resistant, at least at a pressure level which is not especially high. In order to ensure an especially reliable connection for applications in which high pressures occur, preferably the process is such that a cement is applied to the connecting surfaces 33 and 35 on the pole core 9 and on the rotating part 15 before the heated tube body 13 is pressed on. In addition to the holding force produced by the shrinking, in this way an adhesive site and a seal are produced on the connecting surfaces 33 and 35. A cement which forms a sealant and/or filler, in particular an acrylate-based high temperature cement, has proven especially suitable.

The exemplary embodiment of the pole tube 1 produced according to the method according to the invention, which embodiment is shown in FIG. 2, differs from the example of FIG. 1 only by an alternative configuration of the rotating part 15, which forms the displacement guide for the armature 3. In contrast to the example of FIG. 1, the rotating part 15 is made as a cylindrical cup closed on one and, where the end part 37 which forms the cup bottom which is integral with the cup closes off the armature space 11 with its round, flat inner bottom surface 39 and forms a stroke limiter for definition of the end position of the armature 3; said position being on the right side in the drawings, which armature assumes this right-side end position in the absence of energization of the coil winding. Otherwise, the exemplary embodiment from FIG. 2 corresponds to the above-described example, particularly with respect to the connections between the tube body 13 and pole body 9 and rotating part 15, which connections are formed by shrinking on.

In the other exemplary embodiment shown in FIGS. 3 to 5, the tube body 13, in contrast to the above-described examples, is not smooth on its inside, but in its central longitudinal region has a ring body 51 which projects radially to the inside relative to the longitudinal axis 10, and which is bordered axially by inclined planes 53 which, adjoining inclined end edges of pole core 9 and rotating part 15, suitably fills the intermediate space between the pole core 9 and rotating part 15 as a filler piece. The ring body 51 forms a control edge which influences the field on the intermediate space which is used for the magnetic decoupling.

While in the exemplary embodiments of FIGS. 1 and 2, the tube body 13 adjoins both connecting regions with a smooth inside wall on the connecting surfaces 33 and 35 of the pole core 9 and of the rotating part 15 and is fixed thereto by thermally shrinking on, optionally using an additional cementing process; another difference of the example of FIGS. 3 and 5 consists in that, as is apparent only from FIGS. 4 and 5, the respective connecting part 55 of the tube body 13 adjoins the connecting surface 33 on the pole core 9 and the connecting surface 35 on the rotating part 15 with the formation of a toothing. FIG. 5 shows that this toothing is formed by a staggered surface configuration of the connecting surface 33 on the pole core 9 and on the adjoining surface of the connecting part 55. The same applies to the connecting surface 35, which is not shown in FIGS. 4 and 5, on the rotating part 15. On the connecting surfaces 33 and 35, for this purpose, an undercut 57 is formed which is only visible in FIG. 5 and which forms a stop shoulder for a step 59 which is formed on the start of the end section of the inner surface of the connecting part 55 of the tube body 13. This engagement forms a safeguard of the connection against different thermal expansions. To avoid a possible static overdetermination, as shown in FIG. 5, on the end of the connecting part 55 there is a small open space 61 between the bordering surface of the pole core 9. The same applies to the end surface of the connecting part 55 and the rotating part 15, which is not shown in FIGS. 4 and 5. Instead of the toothing by means of only one undercut 57 and a step 59, there could be a different surface configuration, for example, microgrooves and corresponding depressions on the adjoining surfaces or similar surface structures.

1. A method for producing an electromagnetic actuating device, particularly for actuating valves, in which a pole tube (1) which guides an armature (3) within an armature space (11) is formed by configuring a mechanical connection between a tube body (13) and at least one further part (9, 15) of the pole tube (1), for example, a pole core (9), characterized in that the mechanical connection is formed by thermal shrinkage such that the tube body (13) is heated and pressed onto the further part (9, 15).

2. The method according to claim 1, characterized in that the tube body (13) is connected by thermal shrinkage both to the pole core (9) formed by a first rotating part and also to a second rotating part (15) forming the displacement guide of the armature (3) by the heated tube body (13) being pressed onto the outer jacket surfaces (33, 35) of the two rotating parts (9, 15).

3. The method according to claim 1 or 2, characterized in that an adhesive, preferably an adhesive which forms a sealant and/or filler, is applied to connection sites before pressing the heated tube body (13) on.

4. The method according to claim 3, characterized in that an acrylate-based high temperature cement is applied.

5. The method according to claim 1, characterized in that the tube body (13) is formed from a nonmagnetic metal.

6. The method according to claim 5, characterized in that the pole core (9) and second rotating part (15) are connected to one another via the tube body (13) with formation of an intermediate space which effects a magnetic decoupling.

7. The method according to claim 6, characterized in that the intermediate space, which effects a magnetic decoupling, is formed by leaving open an air gap (23) between the pole core (9) and tube body (13).

8. The method according to claim 6, characterized in that on the tube body (13) a ring body (51) is formed which projects radially to the inside relative to the longitudinal axis (10) of the pole tube (1), which as the filler piece of the intermediate space is matched to its shape and dimensions and on the intermediate space forms a control edge for the magnetic field.

9. The method according to claim 2, characterized in that the second rotating part (15) is provided with a closed end (29, 37) which forms a stroke limiter of the armature (3).

10. The method according to claim 9, characterized in that the second rotating part (15) is made with an end part (37) which is integral with it.

11. The method according to claim 9, characterized in that the second rotating part (15) is executed as a hollow cylinder whose one end is provided with a separate end part (29) which forms the stroke limiter by means of a flange connection (31).

12. An actuating device produced according to the method according to claim 1, particularly for actuating valves, which has a pole tube (1) which guides an armature (3) within an armature space (11) with a tube body (13) which is mechanically connected to a further part (9, 15) of the pole tube (1), for example, the pole core (9), by thermal shrinking.

13. The actuating device according to claim 12, characterized in that the tube body (13) is connected both to the pole core (9) on a connecting surface (33) and also to a rotating part (15) forming the displacement guide of the armature (3) on a connecting surface (35).

14. The actuating device according to claim 12, characterized in that at least one connecting surface (33, 35) has a stepped surface configuration (57) which in interaction with a correspondingly stepped configuration (59) of the adjoining surface of the tube body (13) forms a safeguard against a relative axial motion along the pertinent connecting surface (33, 35).

15. The actuating device according to claim 14, characterized in that on each connecting surface (33, 35) there is a step (57) for the interaction with a pertinent step (59) on the tube body (13).
